(19) United States
(12) Patent Application Publication
(10) Pub. No.: US 2014/0082154 A1
(43) Pub. Date: Mar. 20, 2014

(54) FILE SHARING METHOD, TERMINAL AND RELAY SERVER

(71) Applicant: TENCENT TECHNOLOGY (SHENZHEN) COMPANY LIMITED, Shenzhen (CN)

(72) Inventor: JIE LIN, Shenzhen (CN)

(73) Assignee: TENCENT TECHNOLOGY (SHENZHEN) COMPANY LIMITED, Shenzhen (CN)

(21) Appl. No.: 14/089,785

(22) Filed: Nov. 26, 2013

Related U.S. Application Data
(63) Continuation of application No. PCT/CN2013/082619, filed on Aug. 30, 2013.

(30) Foreign Application Priority Data
Aug. 31, 2012 (CN) 201210319306.4

(51) Int. Cl. H04L 29/08

(52) U.S. Cl. CPC H04L 67/02
USPC 709/219

(57) ABSTRACT

A method is provided for sharing files on the Internet. The method includes a relay server receiving an upload request sent from a first terminal, and the upload request contains file information of two or more files. The method also includes the relay server generating an extraction code based on the file information of two or more files, storing the file information of two or more files and the corresponding extraction code, and sending the extraction code to the first terminal. Further, the method includes the relay server receiving the two or more files from the first terminal after the first terminal receives the extraction code and uploads the two or more files to the relay server, and uploading the two or more files to a file server.

### CROSS-REFERENCES TO RELATED APPLICATIONS

This application is a continuation of PCT Patent Application No. PCT/CN2013/082619, filed on Aug. 30, 2013, which claims priority of Chinese Patent Application No. 201210319306.4, filed on Aug. 31, 2012, the entire contents of which are incorporated by reference herein.

### FIELD OF THE INVENTION

The present invention generally relates to computer network technologies and, more particularly, to a file sharing method, terminal and relay server.

### BACKGROUND

With the rapid development of network technologies, uploading files to the Internet or downloading files from the Internet is becoming more and more popular. The existing file uploading technologies, regardless on Personal Computer (PC) or on mobile terminals, are relatively mature technologies. However, the vast majority of file sharing methods supported by the file storage software on the market are based on extraction codes. That is, the user may obtain the file corresponding to the extraction code through an extraction code, and also download the file based on the corresponding extraction code to achieve filing sharing.

However, the existing file sharing technologies have certain limitation. For example, in the existing technology, one extraction code corresponds to only one file. That is, only one file is shared at one time. Sharing multiple files at one time is often not supported. The user needs to perform multiple interactions with the file server to share multiple files when the user needs to upload or download multiple files. Thus, the existing file sharing technologies not only have low efficiency for sharing files, but also cause waste of signaling.

The disclosed methods and devices are directed to solve one or more problems set forth above and other problems.

### BRIEF SUMMARY OF THE DISCLOSURE

One aspect of the present disclosure includes a method for sharing files on the Internet. The method includes a relay server receiving an upload request sent from a first terminal, and the upload request contains file information of two or more files. The method also includes the relay server generating an extraction code based on the file information of two or more files, storing the file information of two or more files and the corresponding extraction code, and sending the extraction code to the first terminal. Further, the method includes the relay server receiving the two or more files from the first terminal after the first terminal receives the extraction code and uploads the two or more files to the relay server, and uploading the two or more files to a file server.

Another aspect of the present disclosure includes a method for sharing files by a terminal device. The method includes the terminal device sending an upload request to a relay server. The upload request contains file information of two or more files and the relay server generates an extraction code based on the file information of two or more files and sends the extraction code to the terminal device. The method also includes the terminal device receiving the extraction code from the relay server and sending the two or more files to the file server.

Another aspect of the present disclosure includes a relay server. The relay server includes a receiving module, a generating module, a storing module, and a sending module. The receiving module is configured to receive an upload request sent from a first terminal. The upload request contains file information of two or more files. The generating module is configured to generate an extraction code based on the file information of two or more files when the relay server receives the upload request sent from the first terminal. Further, the storing module is configured to store the file information of two or more files and the corresponding extraction code, and the sending module is configured to send the extraction code to the first terminal.

Another aspect of the present disclosure includes a terminal device. The terminal device includes a sending module, a receiving module, and a receiving module. The sending module is configured to send an upload request to the relay server. The upload request contains file information of two or more files and the relay server generates an extraction code based on the file information of two or more files and sends the extraction code to the terminal device. The receiving module is configured to receive the extraction code, and the sending module is also configured to send the two or more files to a file server after receiving the extraction code from the relay server.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions of the present invention or the existing technology, the figures which are needed to be used in the description of the present invention or the existing technology are briefly described in the following. Obviously, the figures in the following description are only some embodiments of the present invention, and it is easily for those skilled in the art to obtain other figures based on the following figures without creative work.

FIG. 1 illustrates a flow diagram of an exemplary file sharing method consistent with the disclosed embodiments;

FIG. 2 illustrates a flow diagram of another exemplary file sharing method consistent with the disclosed embodiments;

FIG. 3 illustrates a detailed flow diagram of an exemplary file sharing method consistent with the disclosed embodiments;

FIG. 4 illustrates a structure diagram of another exemplary relay server consistent with the disclosed embodiments;

FIG. 5 illustrates a structure diagram of an exemplary terminal device consistent with the disclosed embodiments;

FIG. 6 illustrates an exemplary operating environment incorporating certain disclosed embodiments; and

FIG. 7 illustrates a block diagram of an exemplary computer system consistent with the disclosed embodiments.

### DETAILED DESCRIPTION

Reference will now be made in detail to exemplary embodiments of the invention, which are illustrated in the accompanying drawings.

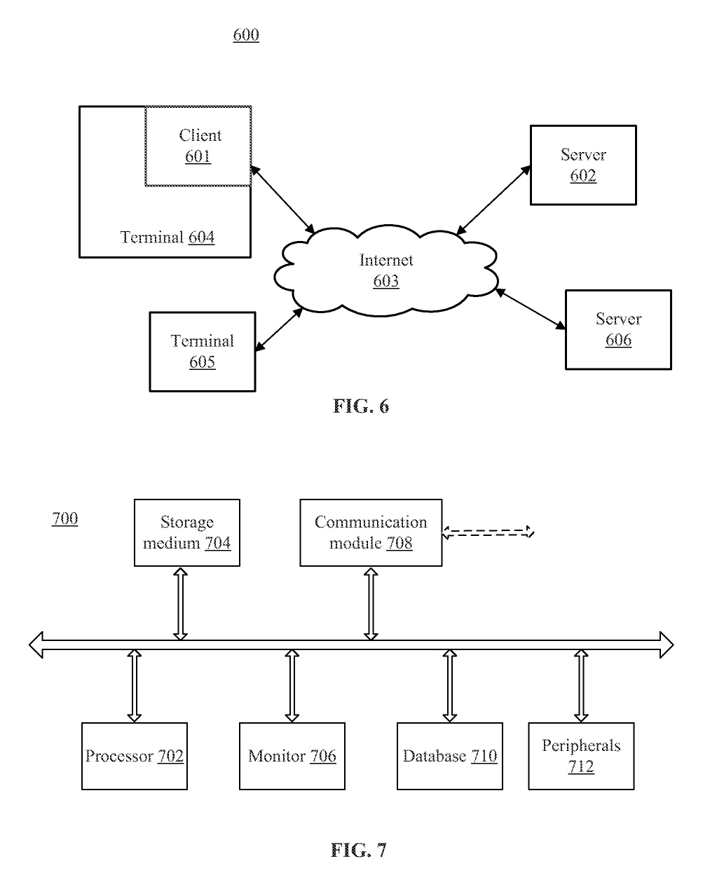

FIG. 6 illustrates an exemplary operating environment 600 incorporating certain disclosed embodiments. As shown in FIG. 5, environment 600 may include a terminal 604, a terminal 605, the Internet 603, a server 602, and a server 606. The Internet 603 may include any appropriate type of communication network for providing network connections to the terminal 604 and the server 602 or among multiple terminals and servers. For example, Internet 603 may include the Internet or other types of computer networks or telecommunication networks, either wired or wireless.

A server, as used herein, may refer to one or more server computers configured to provide certain web server functionalities to provide certain personalized services, which may require any user accessing the services to authenticate to the server before the access. A web server may also include one or more processors to execute computer programs in parallel.

The server 602 and server 606 may include any appropriate server computers configured to provide certain server functionalities, such as a file server functionality for responding a user's request for file sharing operations or other application server. Although only two servers are shown, any number of servers can be included. The server 602 and server 606 may be operated in a cloud or non-cloud computing environment.

Terminal 604 and terminal 605 may include any appropriate type of mobile computing devices, such as mobile phones, smart phones, tablets, notebook computers, or any type of computing platform. A terminal (e.g., terminal 604) may include one or more clients 601. The client 601, as used herein, may include any appropriate mobile application software, hardware, or a combination of application software and hardware to achieve certain client functionalities. For example, client 601 may include a browser, etc. According to actual needs in different terminals, a mobile client may be a browser installed on the terminal for browsing, including various types of existing and future browser installed on terminals. Although only one client 601 is shown in the environment 600, any number of clients 601 may be included.

Terminal 604/605, client 601, and/or server 602/606 may be implemented on any appropriate computing platform. FIG. 6 illustrates a block diagram of an exemplary computer system 700 capable of implementing 604/605, client 601, and/or server 602/606.

As shown in FIG. 7, computer system 700 may include a processor 702, a storage medium 704, a monitor 706, a communication module 708, a database 710, and peripherals 712. Certain devices may be omitted and other devices may be included.

Processor 702 may include any appropriate processor or processors. Further, processor 702 can include multiple cores for multi-thread or parallel processing. Storage medium 704 may include memory modules, such as Read-only memory (ROM), Random Access Memory (RAM), flash memory modules, and erasable and rewritable memory, and mass storages, such as CD-ROM, U-disk, and hard disk, etc. Storage medium 704 may store computer programs for implementing various processes, when executed by processor 702.

Further, peripherals 712 may include I/O devices such as keyboard and mouse, and communication module 708 may include network devices for establishing connections through the communication network. Database 710 may include one or more databases for storing certain data and for performing certain operations on the stored data, such as database searching.

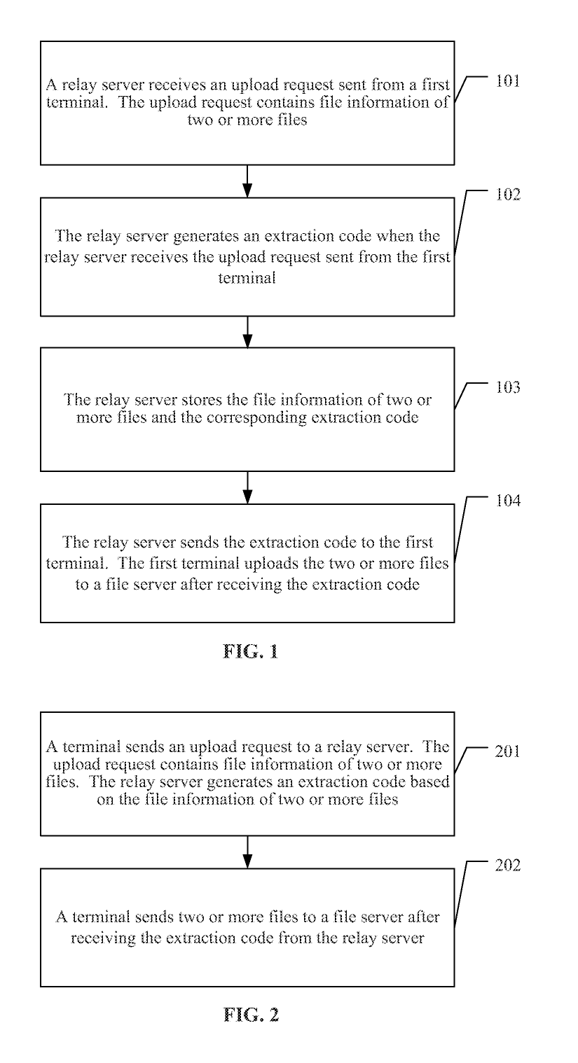

In operation, terminals/clients and servers 602 and 606 may interact with each other to provide a file sharing service to the user(s) of the terminals. More particularly, the server 606 may be a relay server and the server 602 may be a file server. The relay server may be provided to facilitate file sharing among multiple terminals (e.g., terminal 604, terminal 605) through the file server. FIG. 1 illustrates a flow diagram of an exemplary file sharing process consistent with the disclosed embodiments.

The file sharing process may be mainly performed by the relay server, with interactions from the terminals and/or the file server. As shown in FIG. 1, the file sharing process includes the following steps:

Step 101: the relay server receives an upload request sent from a first terminal. The upload request contains file information of two or more files.

The file information includes at least one of a file name and a file characteristic value. The file information may include the file characteristic value (e.g., MD5 value), file size, and the file name, etc. The file characteristic value is generated from binary data of the file using a preset characteristic value algorithm. Each file has a unique corresponding file characteristic value.

Step 102: the relay server generates an extraction code when the relay server receives the upload request sent from the first terminal. The extraction code may be generated randomly based on a preset extraction code generating rule.

Step 103: the relay server stores the file information of the two or more files and the corresponding extraction code.

For example, the file information of two or more files and the corresponding extraction code may be stored in a file database. The file database may also store a corresponding relationship between the file information and the extraction code.

Step 104: the relay server sends the extraction code to the first terminal. The first terminal uploads the two or more files to the file server after receiving the extraction code.

The relay server may be provided to generate the extraction code for the terminal to upload the files. After the extraction code is generated, the relay server sends the extraction code to the terminal. Then, the terminal may upload two or more files to the file server. The upload method may be a direct upload method or an indirect upload method. The direct upload method is that the terminal sends two or more files directly to the file server. The indirect upload method is that the terminal sends two or more files to the relay server, and then the relay server sends the received files to the file server.

Thus, the relay server receives an upload request sent from the first terminal. The upload request contains file information of two or more files. The relay server generates an extraction code when the relay server receives the upload request sent from the first terminal. The relay server then stores the file information of two or more files and the corresponding extraction code. Afterwards, the relay server sends the extraction code to the first terminal. The first terminal uploads the two or more files to a file server after the first terminal receives the extraction code.

When two or more files need to be uploaded in batch, the upload request contains file information of the two or more files. Thus, when the relay server receives the upload request, only one extraction code is generated for two or more files. The relay server stores the file information of two or more files and the corresponding extraction code for sharing files in batch, avoiding multiple interactions for sharing multiple files in the existing technologies. Therefore, the method not only improves efficiency for sharing files but also avoids waste of signaling.

Specifically, based on the technical solutions shown in FIG. 1, the process for generating the extraction code for the files in Step 102 may include the following two steps:

Step 1: the relay server randomly generates the extraction code.

Specifically, there is no specific limitation on the preset extraction code generating algorithm. For example, the relay server may generate the extraction code based on a timestamp when the relay server receives the upload request. Subsequently, when the relay server receives the extraction code, the relay server judges whether the time difference between generating the extraction code and receiving the extraction code is greater than a preset threshold value based on the extraction code. If the time difference is greater than the preset threshold value, the extraction code is expired; otherwise, the extraction code is still valid.

Further, after the extraction code is generated randomly, the relay server judges whether the extraction code already exists in the relay server. If the extraction code already exists in the relay server, Step 2 is implemented; otherwise, the currently generated extraction code is used as the extraction code corresponding to the two or more files.

Step 2: if the extraction code already exists in the relay server, the relay server generates a new extraction code.

After the new extraction code is generated, the relay server judges whether the new extraction code exists in the relay server. The process for generating the new extraction code stops until the relay server confirms that the new extraction code does not exist in the relay server.

The relay server receives an upload request sent from the first terminal. The upload request contains file information of two or more files. The relay server generates an extraction code when the relay server receives the upload request sent from the first terminal. The relay server stores the file information of two or more files and the corresponding extraction code. Afterwards, the relay server sends the extraction code to the first terminal. The first terminal uploads the two or more files to a file server after the first terminal receives the extraction code.

When two or more files need to be uploaded in batch, the same upload request contains file information of two or more files. Thus, when the relay server receives the upload request, only one extraction code is generated for the two or more files. The relay server stores the file information of two or more files and the corresponding extraction code for sharing files in batch, avoiding multiple interactions for sharing multiple files in the existing technologies. Therefore, the method not only improves efficiency for sharing files but also avoids waste of signaling. Further, the relay server judges whether the new extraction code already exists in the relay server. Thus, the file sharing error caused by duplicate extraction code can be avoided. In addition, the relay server generates the corresponding extraction code based on the timestamp when the relay server receives the upload request. Therefore, the validity of the extraction code can be verified.

Specifically, based on the technical solutions shown in FIG. 1, the process for storing the file information of two or more files and the corresponding extraction code in Step 103 includes the following two steps:

Step 103a: based on the received file information of the two or more files, the relay server judges whether the relay server stores any one of file information of two or more files.

Because the relay server may provide services for multiple terminals at the same time, a file may have been uploaded by other terminals. If the file has been uploaded, the relay server stores a corresponding relationship between the file information of the file and the extraction code. Therefore, the storage situation of two or more files in the relay server may be obtained by judging whether any one of file information of two or more files has been stored in the relay server.

Step 103b: if the relay server has stored any one of the file information of the two or more files, the relay server does not need to store this file information again. A corresponding relationship between the stored file information and the currently generated extraction code is created. Both the file information that has not been stored and the generated corresponding extraction code are stored. If the relay server has not stored the file information of the two or more files, both the file information of two or more files and the corresponding extraction code are stored.

Specifically, if the relay server has stored any one of the file information of the two or more files, the relay server obtains the storage information of the file which corresponds to the stored file information. When the relay server confirms that the file corresponding to the stored file information has been uploaded completely based on the storage information, the relay server does not need to store the file information again. A corresponding relationship between the stored file information and the currently generated extraction code is created. Both the file information that has not been stored and the currently generated corresponding extraction code are stored.

Further, when the relay server confirms that the file corresponding to the stored file information is uploaded incompletely based on the storage information, both the stored file information and the generated corresponding extraction code are stored. When the process goes to Step 104, the storage information and the currently generated extraction code are sent to the terminal. Thus, the terminal sends the part of the file which is not uploaded corresponding to the storage information to the relay server based on the storage information.

As used herein, the relay server receives an upload request sent from the first terminal. The upload request contains file information of two or more files. The relay server generates an extraction code when the relay server receives the upload request sent from the first terminal. The relay server stores the file information of two or more files and the corresponding extraction code. Afterwards, the relay server sends the extraction code to the first terminal. The first terminal uploads the two or more files to a file server after the first terminal receives the extraction code.

When two or more files need to be uploaded in batch, the same upload request contains file information of two or more files. Thus, when the relay server receives the upload request, only one extraction code is generated for two or more files. The relay server stores the file information of two or more files and the corresponding extraction code for sharing files in batch, avoiding multiple interactions for sharing multiple files in the existing technologies. Therefore, the method not only improves efficiency for sharing files but also avoids waste of signaling. Further, the uploading situation of two or more files may be obtained by judging whether any one of the file information of the two or more files has been stored in the relay server. If any terminal has uploaded two files or any one of two files, the relay server indicates the first terminal that only file corresponding to the file information that has not been stored in the relay server needs to be uploaded, thus saving network flow.

Further, returning to FIG. 1, after Step 104 is performed, other steps may also be performed. For example, the relay server receives the two or more files sent from the first terminal. The relay server may not only generate the extraction code for the terminal, but also be used as a relay between the terminal and the file server. The relay server receives the two or more files sent from the first terminal.

Further, based on the file information of the two or more files, the relay server verifies the two or more files. After the two or more files pass the verification process, the relay server sends the two or more files to the file server.

The verification process determines whether the two or more files correspond to the file information based on the file information of the two or more files. The specific verification process may verify the file characteristic value or file offset address. If the relay server stores the file information of the two or more files or any one of the two or more files, the first terminal only uploads the file corresponding to the stored file information in Step 104. In the verification process, the relay server judges whether the uploaded file is the file requested to be uploaded in Step 104.

Optionally and/or additionally, the relay server receives a download address of the two or more files sent from the file server.

After the file server receives and stores the two or more files, the file server sends the download address of the two or more files to the relay server. The download address is a web link or Uniform Resource Locator (URL). In addition, the download address may also be a set of one or more addresses. The storage position of the two or more files may be multiple addresses in the file server, an address range in the file server, or one or more servers assigned and managed by the file server. There are no specific limitations on storage modes of the file server.

Further, the relay server stores the file information of the two or more files, the corresponding extraction code, and the corresponding download address of the two or more files.

When the relay server receives the download address of the two or more files, the relay server stores the file information of the two or more files, the corresponding extraction code, and the corresponding download address of the two or more files. That is, a relationship among the download address of the two or more files, the file information, and the extraction code is created. When the relay server receives a download request containing the extraction code in subsequent operations, the relay server sends the corresponding download address to a requester.

Because the relay server sends the extraction code to the terminal, the terminal may share the extraction code with other users or store the extraction code for subsequent operations.

Further, the relay server may receive a download request containing the extraction code sent from a second terminal.

As used herein, the first terminal and the second terminal are only for making a distinction between the upload device and the download device. The first terminal and the second terminal may be the same device, or the different devices, which are only for making a distinction between functions.

After receiving the download request, the relay server obtains the download address of the two or more files based on the extraction code. That is, when the relay server receives the download request, based on the extraction code included in the download request, the relay server obtains the download address of the two or more files corresponding to the extraction code from the file database of the relay server.

Further, the relay server sends the download address of the two or more files to the second terminal. The second terminal downloads the two or more files from the file server based on the download address of the two or more files.

The download address corresponds to the two or more files. Therefore, the second terminal may one-time download the two or more files from the file server based on the download address of the two or more files, achieving the goal of sharing files in batch.

Further, based on the extraction code, the relay server may verify whether the extraction code is valid. If the extraction code is valid, the relay server then obtains the download address of two or more files corresponding to the extraction code.

Through verification process, the relay server determines whether the file information corresponding to the extraction code exists and whether the file corresponding to the extraction code are still stored in the file server.

Further, the relay server may verify the extraction code using any appropriate verification method. For example, the relay server verifies whether the extraction code is expired based on the extraction code. When the time difference between extraction code generating time and the current time is greater than the preset threshold value, the relay server determines that the extraction code is invalid. When the time difference between the extraction code generating time and the current time is less than the preset threshold value, the extraction code is valid.

Due to the timeliness of the file server, when the time period for storing the file in the file server is greater than the preset threshold value, the file server may delete the file. Therefore, the relay server needs to determine whether the file corresponding to the extraction code still stores in the file server based on the time difference between extraction code generating time and the current time. When the time difference between extraction code generating time and the current time is greater than the preset threshold value, the relay server determines that the extraction code is invalid. When the time difference between extraction code generating time and the current time is less than the preset threshold value, the relay server determines that the extraction code is valid.

Further, the relay server may verify whether the extraction code exists based on the extraction code. When the extraction code does not exist, the relay server determines that the extraction code is invalid. When the extraction code exists, the relay server determines that the extraction code is valid.

To ensure the accuracy of file sharing, the relay server judges whether the extraction code exists. When the extraction code does not exist, the relay server determines that the extraction code is invalid. When the extraction code exists, the relay server determines that the extraction code is valid.

When the extraction code is valid, the download address is sent to the second terminal, avoiding waste of signaling due to invalidation of the extraction code or the error of the extraction code.

In addition, the first terminal and the second terminal may be different types of terminals, e.g., a mobile phone, a tablet, a fixed terminal, etc. That is, the files may be shared between different terminals by using the file sharing method shown in the present disclosure. There are no limitations on types of terminals.

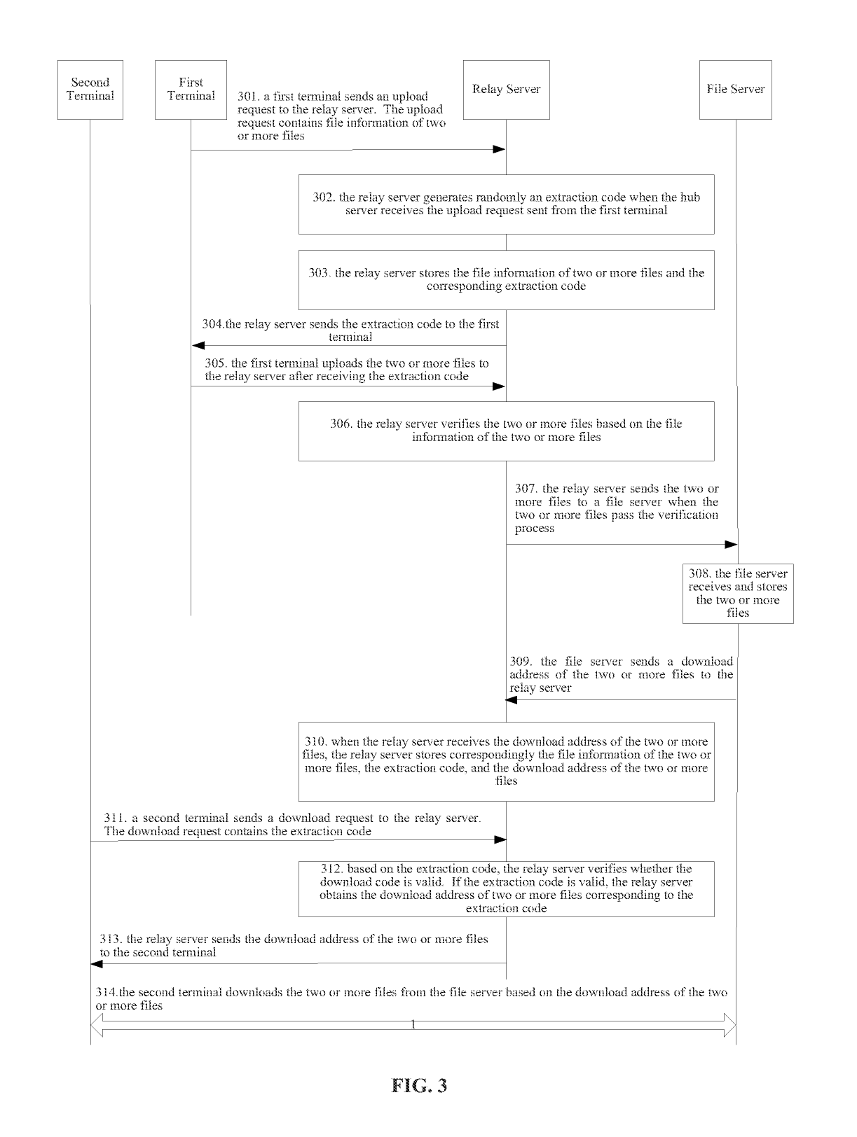

FIG. 2 illustrates a flow diagram of another exemplary file sharing process consistent with the disclosed embodiments. As shown in FIG. 2, the process includes the following steps:

Step 201: a terminal sends an upload request to the relay server. The upload request contains file information of two or more files. Thus, the relay server generates an extraction code based on the file information of two or more files.

Step 202: a terminal sends two or more files to a file server after receiving the extraction code from the relay server.

If the relay server has stored any one of the file information of the two or more files, the relay server obtains the storage information of the file corresponding to the stored file information. When the relay server confirms that the file corresponding to the stored file information has been uploaded completely based on the storage information, the relay server does not need to store the file information again. A corresponding relationship between the stored file information and the currently generated extraction code is created. Both the file information that has not been stored and the generated corresponding extraction code are stored.

Further, when the relay server confirms that the file corresponding to the stored file information is uploaded incompletely based on the storage information, both the file information that has not been stored and the generated corresponding extraction code are stored. Further, the stored information and the currently generated extraction code are sent to the terminal (e.g., Step 104). Thus, based on the stored information, the terminal sends the part of the file which is not uploaded corresponding to the stored information to the relay server in Step 202.

Further, based on the technical solutions shown in FIG. 2, the process that sends two or more files to a file server after the terminal receives the extraction code from the relay server in Step 202 includes the following steps:

The terminal sends two or more files to the relay server after receiving the extraction code from the relay server. Then, the relay server sends the two or more files to the file server.

The relay server generates the extraction code for the terminal to upload the files. After the extraction code is generated, the relay server sends the extraction code to the terminal. Then, the terminal may upload two or more files to the file server. The upload method may be a direct upload method or an indirect upload method. The direct upload method is that the terminal sends two or more files directly to the file server. The indirect upload method is that the terminal sends two or more files to the relay server, and then the relay server sends the received files to the file server.

When two or more files need to be uploaded in batch, the same upload request contains file information of two or more files. Thus, when the relay server receives the upload request, only one extraction code is generated for two or more files. The relay server stores the file information of two or more files and the corresponding extraction code for sharing files in batch, avoiding multiple interactions for sharing multiple files in the existing technologies. Therefore, the method not only improves efficiency for sharing files but also avoids waste of signaling.

FIG. 3 illustrates a detailed flow diagram of another exemplary file sharing process consistent with the disclosed embodiments. As shown in FIG. 3, the flow diagram includes Steps 301 through 314.

Step 301: a first terminal sends an upload request to a relay server. The upload request contains file information of two or more files.

Step 302: the relay server randomly generates an extraction code when the relay server receives the upload request sent from the first terminal.

Step 303: the relay server stores the file information of the two or more files and the corresponding extraction code.

Step 304: the relay server sends the extraction code to the first terminal.

Step 305: the first terminal uploads the two or more files to the relay server after receiving the extraction code.

Step 306: the relay server verifies the two or more files based on the file information of the two or more files.

Step 307: the relay server sends the two or more files to a file server when the two or more files pass the verification process.

Step 308: the file server receives and stores the two or more files.

Step 309: the file server sends a download address of the two or more files to the relay server.

Step 310: when the relay server receives the download address of the two or more files, the relay server stores the file information of the two or more files, the corresponding extraction code, and the corresponding download address of the two or more files.

Step 311: a second terminal sends a download request to the relay server. The download request contains the extraction code.

Step 312: based on the extraction code, the relay server verifies whether the extraction code is valid. If the extraction code is valid, the relay server obtains the download address of two or more files corresponding to the extraction code.

Step 313: the relay server sends the download address of the two or more files to the second terminal.

Step 314: the second terminal downloads the two or more files from the file server based on the download address of the two or more files.

Specifically, when two or more files need to be uploaded in batch, the same upload request contains file information of two or more files. Thus, when the relay server receives the upload request, only one extraction code is generated for two or more files. The relay server stores the file information of two or more files and the corresponding extraction code for sharing files in batch, avoiding multiple interactions for sharing multiple files in the existing technology. Thus, the method not only improves efficiency for sharing files but also avoids waste of signaling.

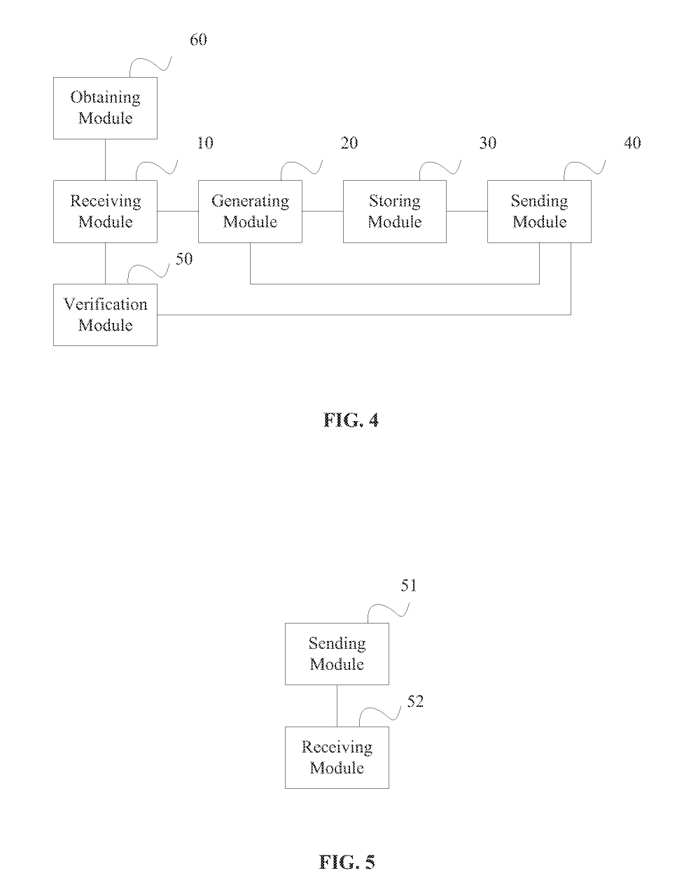

FIG. 4 illustrates a structure diagram of an exemplary relay server consistent with the disclosed embodiments. As shown in FIG. 4, the relay server includes a receiving module 10, a generating module 20, a storing module 30, and a sending module 40. Other components may also be included.

The receiving module 10 is configured to receive an upload request sent from a first terminal. The upload request contains file information of two or more files. The generating module 20 is configured to generate an extraction code when the relay server receives the upload request sent from the first terminal.

Further, the storing module 30 is configured to store the file information of two or more files and the corresponding extraction code. The sending module 40 is configured to send the extraction code to the first terminal. The first terminal uploads the two or more files to a file server after receiving the extraction code.

Further, the generating module 20 is configured to generate randomly the extraction code; when the extraction code already exists in the relay server, the generating module 20 generates a new extraction code.

The receiving module 10 is also configured to receive the two or more files sent from the first terminal.

Accordingly, the relay server also includes a verification module 50 and an obtaining module 60. The verification module 50 is configured to verify the two or more files based on the file information of the two or more files.

The sending module 40 is also configured to send the two or more files to a file server when the two or more files pass the verification process. The receiving module 10 is also configured to receive a download address of the two or more files sent from the file server.

The storing module 30 is also configured to store the file information of the two or more files, the corresponding extraction code, and the corresponding download address of the two or more files. The receiving module 10 is also configured to receive the download request containing the extraction code sent from a second terminal.

The obtaining module 60 is configured to obtain the download address of the two or more files based on the extraction code.

The sending module 40 is also configured to send the download address of the two or more files to the second terminal. The second terminal downloads the two or more files from the file server based on the download address of the two or more files.

Further, the obtaining module 60 includes a verification unit and an obtaining unit. The verification unit is configured to verify whether the extraction code is valid based on the extraction code. The obtaining unit is configured to obtain the download address of the two or more files corresponding to the extraction code when the extraction code is valid.

Further, the verification unit is also configured to verify whether the extraction code is expired based on the extraction code. When the time difference between extraction code generating time and the current time is greater than a preset threshold value, the extraction code is invalid. When the time difference between extraction code generating time and the current time is less than the preset threshold value, the extraction code is valid.

Further, the verification unit is also configured to verify whether the extraction code already exists based on the extraction code. When the extraction code does not exist, the extraction code is invalid. When the extraction code exists, the extraction code is valid. Further, the file information includes at least a file name or a file characteristic value.

When two or more files need to be uploaded in batch, the same upload request contains file information of two or more files. Thus, when the relay server receives the upload request, only one extraction code is generated for two or more files. The relay server stores the file information of two or more files and the corresponding extraction code for sharing files in batch, avoiding multiple interactions for sharing multiple files in the existing technology. Thus, the method not only improves efficiency for sharing files but also avoids waste of signaling.

FIG. 5 illustrates a structure diagram of an exemplary terminal device consistent with the disclosed embodiments. As shown in Figure, the terminal device includes a sending module 51 and a receiving module 52.

The sending module 51 is configured to send an upload request to the relay server. The upload request contains file information of two or more files. Thus, the relay server generates an extraction code based on the file information of two or more files and sends the extraction code to the terminal device. The receiving module 52 is configured to receive the extraction code.

The sending module 51 is also configured to send two or more files to a file server after receiving the extraction code from the relay server. Further, the sending module 51 is also configured to send two or more files to the relay server after receiving the extraction code from the relay server. Then, the relay server sends the two or more files to the file server.

When two or more files need to be uploaded in batch, the same upload request contains file information of two or more files. Thus, when the relay server receives the upload request, only one extraction code is generated for two or more files. The relay server stores the file information of two or more files and the corresponding extraction code for sharing files in batch, avoiding multiple interactions for sharing multiple files in the existing technology. Thus, the method not only improves efficiency for sharing files but also avoids waste of signaling.

It should be noted that, in the above relay server and terminal device for sharing files, each functional module framing is only for illustrative purposes. In practical applications, the above functions are implemented by different functional modules according to the needs. That is, the internal structure of the device for sharing files is divided into different functional modules to complete all or part of the functions described above. In addition, idea about the relay server and the terminal device for sharing files provided in the above embodiment is the same as that of the above method for sharing files. The specific implementation of the devices may refer to the embodiments of the above method, which is not repeated here.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and devices for sharing files, a relay server receives an upload request sent from the first terminal. The upload request contains file information of two or more files. The relay server generates an extraction code when the relay server receives an upload request sent from the first terminal. The relay server stores the file information of two or more files and the corresponding extraction code. Afterwards, the relay server sends the extraction code to the first terminal. The first terminal uploads the two or more files to a file server after the first terminal receives the extraction code. When two or more files need to be uploaded in batch, the same upload request contains file information of two or more files. Thus, when the relay server receives the upload request, only one extraction code is generated for two or more files. The relay server stores the file information of two or more files and the corresponding extraction code for sharing files in batch, avoiding multiple interactions for sharing multiple files in the existing technologies. Therefore, the method not only improves efficiency for sharing files, but also avoids waste of signaling.

What is claimed is:

1. A method for sharing files, comprising:
receiving, by a relay server, an upload request sent from a first terminal, wherein the upload request contains file information of two or more files;
generating, by the relay server, an extraction code based on the file information of two or more files;
storing, by the relay server, the file information of two or more files and the corresponding extraction code;
sending, by the relay server, the extraction code to the first terminal;
receiving, by the relay server, the two or more files from the first terminal after the first terminal receives the extraction code and uploads the two or more files to the relay server; and
uploading, by the relay server, the two or more files to a file server.

2. The method according to claim 1, wherein generating an extraction code further includes:
generating, by the relay server, the extraction code randomly; and
generating, by the relay server, a new extraction code when the extraction code already exists in the relay server.

3. The method according to claim 1, wherein uploading the two or more files to a file server further includes:
verifying, by the relay server, the two or more files based on the file information of the two or more files; and
sending, by the relay server, the two or more files to a file server when the two or more files pass the verification process.

4. The method according to claim 1, further including:
receiving, by the relay server, a download address of the two or more files sent from the file server; and
storing, by the relay server, the file information of the two or more files, the corresponding extraction code, and the corresponding download address of the two or more files.

5. The method according to claim 4, after storing the file information of the two or more files, the corresponding extraction code, and the corresponding download address of the two or more files, further including:
receiving, by the relay server, the download request containing the extraction code sent from a second terminal;
obtaining, by the relay server, the download address of the two or more files based on the extraction code;
sending, by the relay server, the download address of the two or more files to the second terminal; and
downloading, by the second terminal, the two or more files from the file server based on the download address of the two or more files.

6. The method according to claim 5, wherein obtaining the download address of the two or more files based on the extraction code further includes:
verifying, by the relay server, whether the extraction code is valid based on the extraction code; and
obtaining, by the relay server, the download address of the two or more files corresponding to the extraction code when the extraction code is valid.

7. The method according to claim 6, wherein verifying whether the extraction code is valid based on the extraction code further includes:
verifying, by the relay server, whether the extraction code is expired based on the extraction code, wherein:
when the time difference between extraction code generating time and the current time is greater than a preset threshold value, the relay server verifies that the extraction code is invalid;
when the time difference between extraction code generating time and the current time is less than the preset threshold value, the relay server verifies that the extraction code is valid; and
verifying, by the relay server, whether the extraction code already exists based on the extraction code, wherein:
when the extraction code does not exist, the relay server verifies that the extraction code is invalid;
when the extraction code exists, the relay server verifies that the extraction code is valid.

8. The method according to claim 1, wherein:
the file information includes at least any one of a file name and a file characteristic value.

9. A method for sharing files by a terminal device, comprising:
sending, by the terminal device, an upload request to a relay server, wherein the upload request contains file information of two or more files and the relay server generates an extraction code based on the file information of two or more files and sends the extraction code to the terminal device;
receiving, by the terminal device, the extraction code from the relay server; and
sending, by the terminal device, the two or more files to the file server.

10. The method according to claim 9, wherein sending the two or more files to the file server after the terminal device receives the extraction code from the relay server further includes:
sending, by the terminal device, two or more files to the relay server; and
sending, by the relay server, the two or more files to the file server.

11. A relay server, comprising:
a receiving module configured to receive an upload request sent from a first terminal, wherein the upload request contains file information of two or more files;
a generating module configured to generate an extraction code based on the file information of two or more files when the relay server receives the upload request sent from the first terminal;
a storing module configured to store the file information of two or more files and the corresponding extraction code; and
a sending module configured to send the extraction code to the first terminal.

12. The relay server according to claim 11, wherein the generating module is further configured to:
generate the extraction code randomly; and
generate a new extraction code when the extraction code already exists in the relay server.

13. The relay server according to claim 11, wherein the receiving module is configured to receive the two or more files sent from the first terminal, and the relay server further includes:
a verification module configured to verify the two or more files based on the file information of the two or more files, wherein the sending module is further configured to send the two or more files to a file server when the two or more files pass the verification process.

14. The relay server according to claim 11, wherein:
the receiving module is further configured to receive a download address of the two or more files sent from the file server; and
the storing module is further configured to store the file information of the two or more files, the corresponding extraction code, and the corresponding download address of the two or more files.

15. The relay server according to claim 14, wherein the receiving module is further configured to receive the download request containing the extraction code sent from the second terminal, the relay server further includes:
an obtaining module configured to obtain the download address of the two or more files based on the extraction code, wherein the sending module is further configured to send the download address of the two or more files to the second terminal.

16. The relay server according to claim 15, wherein an obtaining module is configured to obtain the download address of the two or more files based on the extraction code, and the obtaining module further includes:
a verification unit configured to verify whether the extraction code is valid based on the extraction code; and
an obtaining unit configured to obtain the download address of the two or more files corresponding to the extraction code when the extraction code is valid.

17. The relay server according to claim 16, wherein the verification unit is further configured to:
verify whether the extraction code is expired based on the extraction code, wherein:
when the time difference between extraction code generating time and the current time is greater than a preset threshold value, the verification unit verifies that the extraction code is invalid;
when the time difference between extraction code generating time and the current time is less than the preset threshold value, the verification unit verifies that the extraction code is valid; and
verify whether the extraction code already exists based on the extraction code, wherein:
when the extraction code does not exist, the verification unit verifies that the extraction code is invalid;
when the extraction code exists, the verification unit verifies that the extraction code is valid.

18. The relay server according to claim 11, wherein:
the file information includes at least any one of a file name and a file characteristic value.

19. A terminal device, comprising:
a sending module configured to send an upload request to a relay server, wherein the upload request contains file information of two or more files and the relay server generates an extraction code based on the file information of two or more files and sends the extraction code to the terminal device; and
a receiving module configured to receive the extraction code, wherein the sending module also configured to send the two or more files to a file server after receiving the extraction code from the relay server.

20. The terminal device according to claim 19, wherein the sending module is further configured to:
send the two or more files to the relay server after receiving the extraction code from the relay server, and the relay server sends the two or more files to the file server.
